(19) United States
(12) Patent Application Publication
(10) Pub. No.: US 2024/0395060 A1
(43) Pub. Date: Nov. 28, 2024

(54) SINGLE EXTRACELLULAR VESICLE SORTING BASED ON SURFACE BIOMARKERS

(71) Applicants: SONY GROUP CORPORATION, Tokyo (JP); Sony Corporation of America, New York, NY (US)

(72) Inventors: Thanh Nguyen, Gaithersburg, MD (US); Michael Zordan, Boulder Creek, CA (US); Ming-Chang Liu, San Jose, CA (US); Ko-Kai Albert Huang, San Jose, CA (US); Haipeng Tang, Sunnyvale, CA (US); Su-Hui Chiang, San Jose, CA (US)

(21) Appl. No.: 18/200,474

(22) Filed: May 22, 2023

(51) Int. Cl. G06V 20/69; G06V 10/82

(52) U.S. Cl. CPC G06V 20/698; G06V 10/82

(57) ABSTRACT

An Imaging-activated cell sorter (IACS) provides spatial resolution to facilitate single EVs sorting based on fluorescence markers. The imaging is used to detect if the fluorescence (FL) signal is located in a single spot or is in multiple spots (e.g., a swarm). The images can be a single image, or multiple spatially registered FL images.

### FIELD OF THE INVENTION

The present invention relates to extracellular vesicle sorting. More specifically, the present invention relates to image-based extracellular vesicle sorting.

### BACKGROUND OF THE INVENTION

High-magnification microscopy is able to be used to analyze Extracellular Vesicles (EVs) but has no sorting capability.

Traditional flow cytometers measure the total intensity of fluorescence or light scatter, so it is difficult to distinguish between a single large EV from a swarm of smaller EVs.

EVs are heterogeneous in size, intensity, and morphology which makes it difficult to detect a single EV from a swarm/noise.

### SUMMARY OF THE INVENTION

An Imaging-activated cell sorter (IACS) provides spatial resolution to facilitate single EVs sorting based on fluorescence markers. The imaging is used to detect if the fluorescence (FL) signal is located in a single spot or is in multiple spots (e.g., a swarm). The images can be a single image, or multiple spatially registered FL images.

In one aspect, a method programmed in a non-transitory memory of a device comprises receiving input at one or more neural networks and classifying the input into one or more classifications using image analysis and machine learning based on fluorescence related to biomarkers in the input with the one or more neural networks. The input comprises fluorescence images. Classifying the input into one or more classifications is based on detecting a single point of intensity above a threshold. Classifying the input into one or more classifications is based on detecting a plurality of points of intensity above a threshold. Classifying the input into one or more classifications is based on determining a spot count of intensity greater than a threshold. Classifying the input into one or more classifications includes detecting noise. The method further comprises separating the input based on detection of the biomarkers.

In another aspect, an apparatus comprises a non-transitory memory for storing an application, the application for: receiving input at one or more neural networks and classifying the input into one or more classifications using image analysis and machine learning based on fluorescence related to biomarkers in the input with the one or more neural networks and a processor configured for processing the application. The input comprises fluorescence images. Classifying the input into one or more classifications is based on detecting a single point of intensity above a threshold. Classifying the input into one or more classifications is based on detecting a plurality of points of intensity above a threshold. Classifying the input into one or more classifications is based on determining a spat count of intensity greater than a threshold. Classifying the input into one or more classifications includes detecting noise. The application is further for separating the input based on detection of the biomarkers.

In another aspect, a system comprises a first computing device configured for sending one or more fluorescent images of extracellular vesicles to a second computing device and the second computing device configured for: receiving the one or more fluorescent images of extracellular vesicles at one or more neural networks and classifying the one or more fluorescent images of extracellular vesicles into one or more classifications using image analysis and machine learning based on fluorescence related to biomarkers in the one or more fluorescent images of extracellular vesicles with the one or more neural networks. Classifying the one or more fluorescent images of extracellular vesicles into one or more classifications is based on detecting a single point of intensity above a threshold. Classifying the one or more fluorescent images of extracellular vesicles into one or more classifications is based on detecting a plurality of points of intensity above a threshold. Classifying the one or more fluorescent images of extracellular vesicles into one or more classifications is based on determining a spot count of intensity greater than a threshold. Classifying the one or more fluorescent images of extracellular vesicles into one or more classifications includes detecting noise. The second computing device is further configured for separating the one or more fluorescent images of extracellular vesicles based on detection of the biomarkers.

### BRIEF DESCRIPTION OF THE DRAWINGS

FIG. 1 illustrates a diagram of a secreting cell according to some embodiments.

FIG. 2 illustrates exemplary fluorescent images of EVs according to some embodiments.

FIG. 3 illustrates an exemplary EV application according to some embodiments.

FIG. 4 illustrates a diagram of an exemplary neural network architecture to perform EV sorting according to some embodiments.

FIG. 5 illustrates a diagram of an application for EV sorting according to some embodiments.

FIG. 6 illustrates a flowchart of a method of sorting EVs according to some embodiments.

FIG. 7 illustrates a block diagram of an exemplary computing device configured to implement the EV sorting implementation according to some embodiments.

### DETAILED DESCRIPTION OF THE PREFERRED EMBODIMENT

Extracellular Vesicles (EVs) are small particles secreted by cells into bodily fluids. EVs carry biomolecular cargo (e.g., nucleic acids, proteins, cytokines) and are a pathway for intercellular signaling and communication. There are several types of EVs which have different sizes and formation pathways (biogenesis). EVs contain cell surface proteins from the cell they are derived. These proteins can be labeled with fluorescent antibodies to identify which type of EV is present. Exosomes are the most commonly researched type of EV.

An Imaging-activated cell sorter (IACS) provides spatial resolution to facilitate single EVs sorting based on fluorescence markers. The imaging is used to detect if the fluorescence (FL) signal is located in a single spot or is in multiple spots (e.g., a swarm). The images can be a single image, or multiple spatially registered FL images.

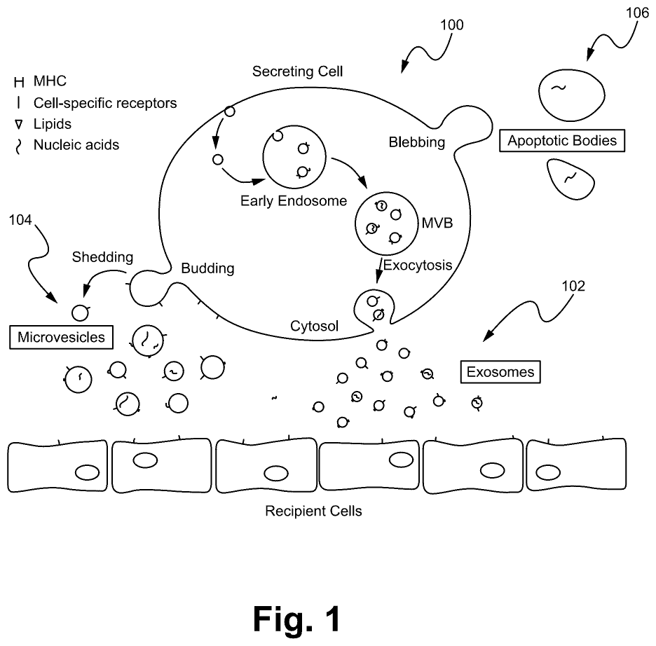

FIG. 1 illustrates a diagram of a secreting cell according to some embodiments. A cell 100 is able to secret EVs such as exosomes 102, microvesicles 104 and apoptotic bodies 106. The exosomes 102 are 30-100 run and are formed in endosomes to become multivesicular bodies, secreted into the extracellular environment when the MVB fuses with the plasma membrane. The microvesicles 104 are 100-1,000 nm and are an outward budding of a cell membrane directly into an extracellular environment. The apoptotic bodies 1-5 μm and are formed through apoptotic fragmentation and blebbing.

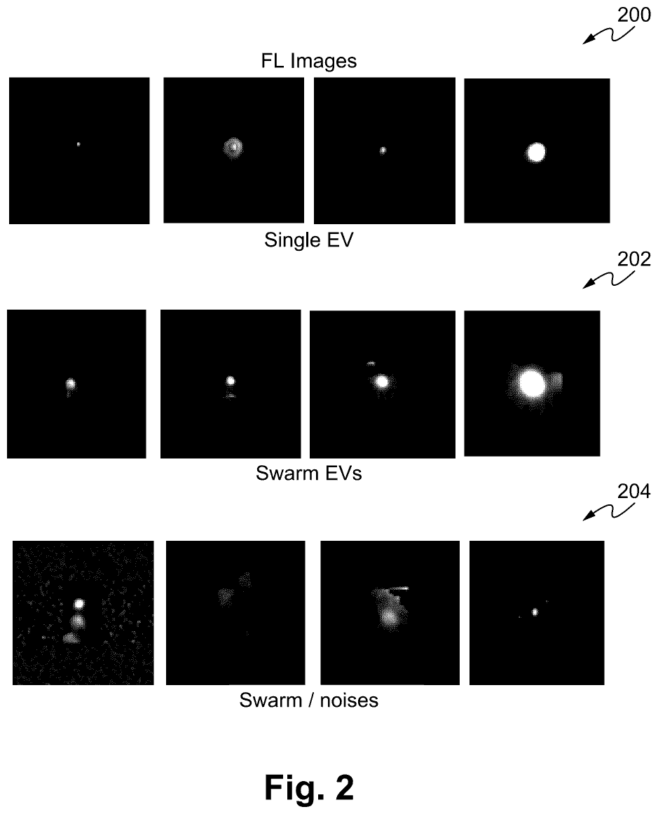

FIG. 2 illustrates exemplary fluorescent images of EVs according to some embodiments. Single EVs 200, swarm EVs 202 and swarms/noises 204 are shown. Using imaging sorting, the various EVs are able to be detected and sorted.

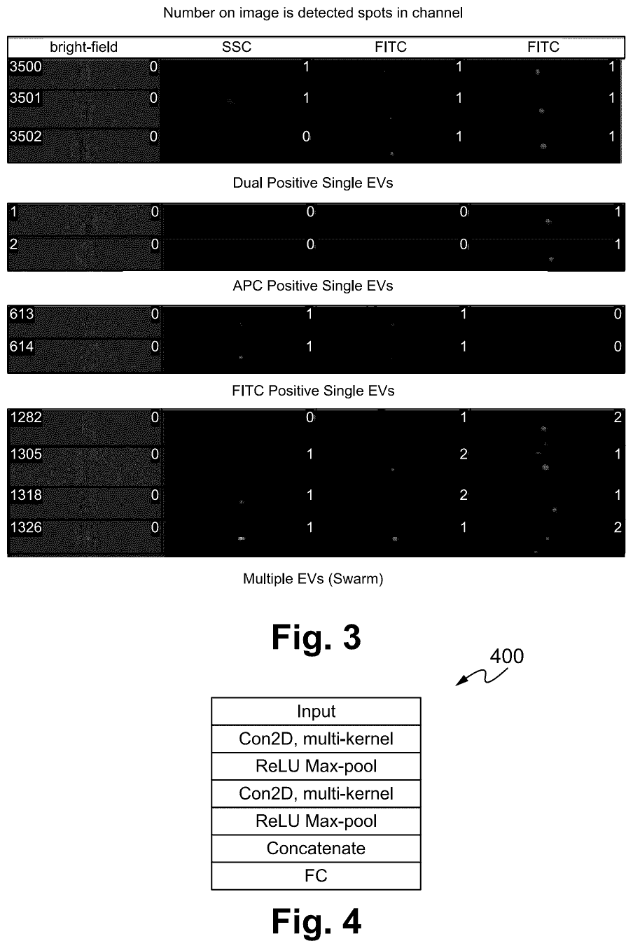

FIG. 3 illustrates an exemplary EV application according to some embodiments. A sample of EVs were stained with two fluorescent biomarkers (antibodies): Fluorescein Isolthiocynate (FITC) and Allophycocyanin (APC). There are three types of EVs that are detectable: those that are single positive for APC and FITC respectively, and EVs that are positive for both FITC and APC. There are two important classification tasks: identify single EVs from swarms of multiple events, and identify the type of single EV based on FL image(s). Although two specific fluorescent biomarkers were used in the example, any fluorescent biomarker and any number of fluorescent biomarkers are able to be used.

FIG. 4 illustrates a diagram of an exemplary neural network architecture to perform EV sorting according to some embodiments. The exemplary neural network 400 includes two convolutional layers and one fully connected (FC) layer. Multiple kernels extract abundant features with different fine-grained levels. The exemplary neural network 400 is able to perform a fast inference: more than 2,000 images per second on an NVIDIA RTX 3090. The neural network 400 is accurate: 98.6% precision with 97.3% recall for single cell identification when excluding 5C noise events on the public available WBC2020 dataset. The neural network 400 is able to be integrated with other sorting modules.

Although a specific exemplary neural network architecture is described, the neural network 400 is not limited to a specific architecture. For example, the neural network 400 is able to include fewer, additional or different components such as fewer convolutional layers, multiple GPUs or a different GPU.

The neural network 400 receives input (e.g., many images of cells), processes the input as described herein using machine learning to extract features and generate an output such as labeling each image as a single EV, a swarm, noise or another label. The neural network 400 is able to be trained using multiple datasets.

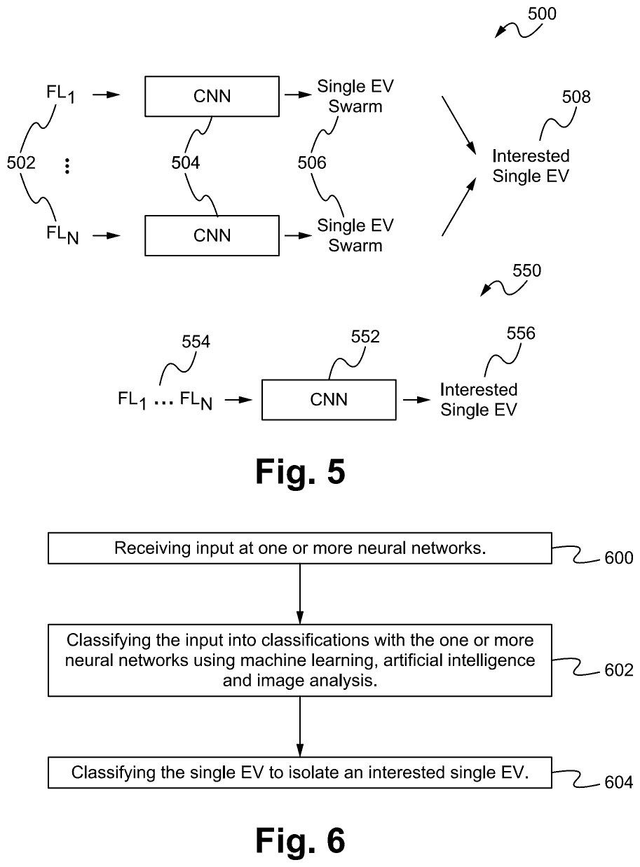

FIG. 5 illustrates a diagram of an application for EV sorting according to some embodiments. A neural network module is able to distinguish a single EV from swarms and noises, and identify the interested EV populations when being applied to multiple biomarkers of inputs in parallel.

In a first implementation 500, multiple Convolutional Neural Networks (CNNs) 502 are utilized. Each CNN 502 receives an input 504 (e.g., fluorescent image) to analyze. Using machine learning, each CNN 502 is able to classify the input 504 into a classification 506 such as having a single EV, a swarm, noise or something else. In some embodiments, further analysis is performed to classify the single EVs into another classification 508 such as interested or not interested, based on a detected biomarker.

In a second implementation 550, a single CNN 552 is utilized. The CNN 552 receives an input 554 (e.g., fluorescent images) to analyze. Using machine learning, the CNN 552 is able to classify the input 554 into a classification 556 (e.g., an interested single EV), by detecting single EVs and based on a detected biomarker.

A CNN is trained using a training set generated using a spot count feature calculation. For example, the CNN is trained to determine if there are multiple points of fluorescence or if there is a single point of fluorescence (e.g., a spot count greater than a threshold). Furthering the example, each pixel is able to be analyzed to determine the fluorescence of that pixel, and if the pixel fluorescence is that of a single EV, then the image is classified as a single EV, and if the pixel fluorescence is that of a swarm, then the image is classified as a swarm. For example, a single EV may have a single group of pixels with high fluorescence in a generally circular shape; whereas, a swarm may have dark pixels between multiple groups of high fluorescent circular shapes. In another example, a single EV has a single point of high fluorescence whereas a swarm may have multiple points of high fluorescence, possibly separated by points of no, low or lower fluorescence. The CNN is able to continuously learn via training and analysis how to distinguish a single EV from a swarm and/or other non-single EV images using image analysis.

With an imaging implementation using one or more CNNs, it is possible to determine if it is one EV that tests positive for two markers (e.g., double positive) or two separate EVs where each one test positive for a separate marker (e.g., a first EV tests positive for a first marker, and a second EV tests positive for a second marker).

In some embodiments, the application for EV sorting is able to be used in conjunction with cell sorting applications such as nuclear translocation, immunoflowfish, EVs and others.

FIG. 6 illustrates a flowchart of a method of sorting EVs according to some embodiments. In the step 600, input is received at one or more neural networks The input is able to include fluorescence images or other images.

In the step 602, the one or more CNNs use machine learning, artificial intelligence and image analysis to classify the input into classifications. As the CNNs analyze more input, the CNNs are able to receive feedback and learn how to distinguish and classify each input. For example, the CNNs focus on intensity and specifically whether or not there are multiple points of high intensity (e.g., above a threshold), which is able to be used to detect a swarm. Furthering the example, with additional learning, the threshold for “high” intensity is able to be adjusted to increase the accuracy of detection. In another example, with further learning, two or more thresholds of intensity (e.g., a high intensity threshold and a low intensity threshold) are able to be used to help classify the input. Machine learning is able to help in the detection of noise. As more and more images are analyzed, different types of noise are able to be detected and stored for further analysis. Any type of image analysis is able to be utilized such as pixel analysis of intensity whereby a layout of the pixel intensity is analyzed to determine if there is single point of intensity or multiple points of intensity (e.g., high valued pixels separated by low value pixels would indicate multiple points of intensity). Masking, segmentation and other image processing implementations are able to be utilized. The classifications are able to include a single EV, a swarm, noise and/or any other classification.

In the step 604, the input (e.g., images) classified as a single EV are further classified to isolate an interested single EV. For example, the EVs are able to be sorted based on biomarkers. Furthering the example, the input may include many images which are classified as having single EVs, where some of the EVs include biomarker X and other EVs include biomarker Y. The images are able to be classified by color. For example, biomarker X is red and biomarker Y is blue, and the colors are able to be detected and separated. A device or system is able to be configured to isolate only EVs with biomarker. X, for example. In another example, the EVs are able to have two separate classifications-one of biomarker X and one of biomarker Y.

In some embodiments, the order of the steps is modified. In some embodiments, fewer or additional steps are implemented. For example, a step of acquiring the input is included. In another example, the steps 602 and 604 are combined into one classification implementation.

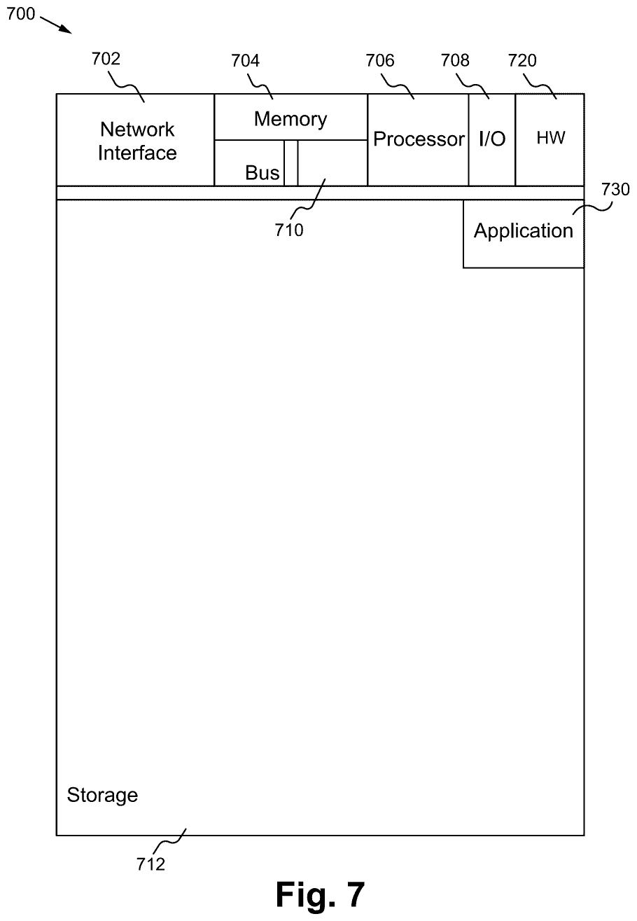

FIG. 7 illustrates a block diagram of an exemplary computing device configured to implement the EV sorting implementation according to some embodiments. The computing device 700 is able to be used to acquire, store, compute, process, communicate and/or display information such as images and videos. The computing device 700 is able to implement any of the EV sorting aspects. In general, a hardware structure suitable far implementing the computing device 700 includes a network interface 702, a memory 704, processors 706, I/O device(s) 708, a bus 710 and a storage device 712. The choice of processor(s) is not critical as long as suitable processor(s) with sufficient speed are chosen. The processors 706 are able to include multiple Central Processing Units (CPUs). The processors 706 and/or hardware 720 are able to include one or mare Graphics Processing Units (GPUs) for efficient EV sorting based on the neural network. Each GPU should be equipped with sufficient GPU memory to perform EV sorting. The memory 704 is able to be any conventional computer memory known in the art. The storage device 712 is able to include a hard drive, CDROM, CDRW, DVD, DVDRW, High Definition disc/drive, ultra-HD drive, flash memory card or any other storage device. The computing device 700 is able to include one or more network interfaces 702. An example of a network interface includes a network card connected to an Ethernet or other type of LAN. The I/O device(s) 708 are able to include one or more of the following: keyboard, mouse, monitor, screen, printer, modem, touchscreen, button interface and other devices. EV sorting application(s) 730 used to implement the framework are likely to be stored in the storage device 712 and memory 704 and processed as applications are typically processed. More or fewer components shown in FIG. 7 are able to be included in the computing device 700. In some embodiments, EV sorting hardware 720 is included. Although the computing device 700 in FIG. 7 includes applications 730 and hardware 720 for the EV sorting implementation, the EV sorting implementation is able to be implemented on a computing device in hardware, firmware, software or any combination thereof. For example, in some embodiments, the EV sorting applications 730 are programmed in a memory and executed using a processor. In another example, in same embodiments, the EV sorting hardware 720 is programmed hardware logic including gates specifically designed to implement the EV sorting implementation.

In some embodiments, the EV sorting application(s) 730 include several applications and/or modules. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, high definition disc writer/player, ultra high definition disc writer/player), a television, a home entertainment system, an augmented reality device, a virtual reality device, smart jewelry (e.g., smart watch), a vehicle (e.g., a self-driving vehicle) or any other suitable computing device.

To utilize the EV sorting described herein, devices such as a flow cytometer with an imaging system (e.g., one or several cameras or detectors) are used to acquire content, and a device is able to process the acquired content. Some imaging systems do not use cameras and reconstruct images from pulse processing from photodiodes, photomultiplier tubes or other implementations. The EV sorting implementation is able to be implemented with user assistance or automatically without user involvement.

In operation, compared to other implementations, the EV sorting implementation described herein is much more precise and is faster. The EV sorting implementation enables single EV population sorting which outperforms traditional FAGS and allows users to scale up from single or multiple-biomarker EV sorting. For example, the EV sorting implementation described herein has precision greater than 98.6% with 97.3% recall. The latency of the EV sorting implementation is small and allows greater than 2,000 events per second. The EV sorting implementation is able to be integrated with downstream applications.

### Some Embodiments of Single Extracellular Vesicle Sorting Based on Surface Biomarkers

1. A method programmed in a non-transitory memory of a device comprising:
   receiving input at one or more neural networks; and
   classifying the input into one or more classifications using image analysis and machine learning based on fluorescence related to biomarkers in the input with the one or more neural networks.
2. The method of clause 1 wherein the input comprises fluorescence images.
3. The method of clause 1 wherein classifying the input into one or more classifications is based on detecting a single paint of intensity above a threshold.
4. The method of clause 1 wherein classifying the input into one or more classifications is based an detecting a plurality of points of intensity above a threshold.
5. The method of clause 1 wherein classifying the input into one or more classifications is based on determining a spot count of intensity greater than a threshold.
6. The method of clause 1 wherein classifying the input into one or more classifications includes detecting noise.
7. The method of clause 1 further comprising separating the input based on detection of the biomarkers.
8. An apparatus comprising:
   a non-transitory memory for storing an application, the application for:
      receiving input at one or more neural networks; and
      classifying the input into one or more classifications using image analysis and machine learning based an fluorescence related to biomarkers in the input with the one or more neural networks; and
   a processor configured for processing the application.
9. The apparatus of clause 8 wherein the input comprises fluorescence images.
10. The apparatus of clause 8 wherein classifying the input into one or more classifications is based on detecting a single point of intensity above a threshold.
11. The apparatus of clause 8 wherein classifying the input into one or more classifications is based on detecting a plurality of points of intensity above a threshold.
12. The apparatus of clause. 8 wherein classifying the input into one or more classifications is based on determining a spot count of intensity greater than a threshold.
13. The apparatus of clause 8 wherein classifying the input into one or more classifications includes detecting noise.
14. The apparatus of clause 8 wherein the application is further for separating the input based an detection of the biomarkers.
15. A system comprising:
   a first computing device configured for sending one or more fluorescent images of extracellular vesicles to a second computing device; and
   the second computing device configured for:
      receiving the one or more fluorescent images of extracellular vesicles at one or more neural networks; and
      classifying the one or more fluorescent images of extracellular vesicles into one or more classifications using image analysis and machine learning based on fluorescence related to biomarkers in the one or more fluorescent images of extracellular vesicles with the one or more neural networks.
16. The system of clause 15 wherein classifying the one or more fluorescent images of extracellular vesicles into one or more classifications is based on detecting a single point of intensity above a threshold.
17. The system of clause 15 wherein classifying the one or more fluorescent images of extracellular vesicles into one or more classifications is based on detecting a plurality of points of intensity above a threshold.
18. The system of clause 15 wherein classifying the one or more fluorescent images of extracellular vesicles into one or more classifications is based on determining a spot count of intensity greater than a threshold.
19. The system of clause 15 wherein classifying the one or more fluorescent images of extracellular vesicles into one or more classifications includes detecting noise.
20. The system of clause 15 wherein the second computing device is further configured for separating the one or more fluorescent images of extracellular vesicles based on detection of the biomarkers.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method programmed in a non-transitory memory of a device comprising:
receiving input at one or more neural networks; and
classifying the input into one or more classifications using image analysis and machine learning based on fluorescence related to biomarkers in the input with the one or more neural networks.

2. The method of claim 1 wherein the input comprises fluorescence images.

3. The method of claim 1 wherein classifying the input into one or more classifications is based on detecting a single paint of intensity above a threshold.

4. The method of claim 1 wherein classifying the input into one or more classifications is based an detecting a plurality of points of intensity above a threshold.

5. The method of claim 1 wherein classifying the input into one or more classifications is based on determining a spot count of intensity greater than a threshold.

6. The method of claim 1 wherein classifying the input into one or more classifications includes detecting noise.

7. The method of claim 1 further comprising separating the input based on detection of the biomarkers.

8. An apparatus comprising:
a non-transitory memory for storing an application, the application for:
receiving input at one or more neural networks; and
classifying the input into one or more classifications using image analysis and machine learning based an fluorescence related to biomarkers in the input with the one or more neural networks; and
a processor configured for processing the application.

9. The apparatus of claim 8 wherein the input comprises fluorescence images.

10. The apparatus of claim 8 wherein classifying the input into one or more classifications is based on detecting a single point of intensity above a threshold.

11. The apparatus of claim 8 wherein classifying the input into one or more classifications is based on detecting a plurality of points of intensity above a threshold.

12. The apparatus of claim 8 wherein classifying the input into one or more classifications is based on determining a spot count of intensity greater than a threshold.

13. The apparatus of claim 8 wherein classifying the input into one or more classifications includes detecting noise.

14. The apparatus of claim 8 wherein the application is further for separating the input based an detection of the biomarkers.

15. A system comprising:
a first computing device configured for sending one or more fluorescent images of extracellular vesicles to a second computing device; and
the second computing device configured for:
receiving the one or more fluorescent images of extracellular vesicles at one or more neural networks; and
classifying the one or more fluorescent images of extracellular vesicles into one or more classifications using image analysis and machine learning based on fluorescence related to biomarkers in the one or more fluorescent images of extracellular vesicles with the one or more neural networks.

16. The system of claim 15 wherein classifying the one or more fluorescent images of extracellular vesicles into one or more classifications is based on detecting a single point of intensity above a threshold.

17. The system of claim 15 wherein classifying the one or more fluorescent images of extracellular vesicles into one or more classifications is based on detecting a plurality of points of intensity above a threshold.

18. The system of claim 15 wherein classifying the one or more fluorescent images of extracellular vesicles into one or more classifications is based on determining a spot count of intensity greater than a threshold.

19. The system of claim 15 wherein classifying the one or more fluorescent images of extracellular vesicles into one or more classifications includes detecting noise.

20. The system of claim 15 wherein the second computing device is further configured for separating the one or more fluorescent images of extracellular vesicles based on detection of the biomarkers.
